(19) United States
(12) Patent Application Publication
(10) Pub. No.: US 2019/0377722 A1
(43) Pub. Date: Dec. 12, 2019

(54) ARRAY STRUCTURES

(71) Applicant: Walmart Apollo, LLC, Bentonville, AR (US)

(72) Inventors: David Stefferud, Fayetteville, AR (US); Grant E. Mora, Rogers, AR (US); Declan Kenny, Bentonville, AR (US)

(21) Appl. No.: 16/389,970

(22) Filed: Apr. 21, 2019

Related U.S. Application Data
(60) Provisional application No. 62/681,622, filed on Jun. 6, 2018.

(51) Int. Cl. G06F 16/23; G06F 16/22; H04L 29/08

(52) U.S. Cl. CPC G06F 16/2365; G06F 16/2379; H04L 9/0643; G06F 16/2264; H04L 67/104; G06F 16/2237

(57) ABSTRACT

Systems and methods are disclosed for permitting nodes of a federated system to quickly and efficiently evaluate themselves for compliance or non-compliance with a set of requirements and detection of vulnerabilities. Both hardware and software configurations may be rapidly evaluated in real-time, using a multi-dimensional bit array, by hashing a configuration and using the value as a look-up index in a peer-to-peer distributed ledger. Speed is provided by the distributed process in which the nodes evaluate themselves, and scalability is achieved because the look-up speed is largely independent of increases in size and complexity. Blockchain technology ensures trustworthy data and stores allowable configurations according to hash values, and secure validated means of communication are leveraged to share results and updates.

### BACKGROUND

Federated architecture (FA) allows interoperability and information sharing between semi-autonomous information technology systems and applications, using a controlled sharing and exchange of information among autonomous components by communication via messages. Typically, the different cooperating components have a high degree of autonomy and adhere to common models by using defined interfaces. Determining allowable configurations of technology among semi-autonomous information technology systems and applications may be time consuming and prone to error when there are complexities involved, such as required dependencies.

### SUMMARY

Systems and methods are disclosed for permitting nodes of a federated system to quickly and efficiently evaluate themselves for compliance or non-compliance with a set of requirements and detection of vulnerabilities. Both hardware and software configurations may be rapidly evaluated in real-time, using a multi-dimensional bit array, by hashing a configuration and using the value as a look-up index in a peer-to-peer distributed ledger. Speed is provided by the distributed process in which the nodes evaluate themselves, and scalability is achieved because the look-up speed is largely independent of increases in size and complexity. Blockchain technology ensures trustworthy data and stores allowable configurations according to hash values, and secure validated means of communication are leveraged to share results and updates.

Some embodiments of a system for ensuring trustworthy configuration, implemented on at least one processor, may comprise: a plurality of endpoint nodes, each endpoint node comprising: a processor; and a non-transitory computer-readable medium storing instructions that are operative when executed by the processor to: receive array structure data; detect a trigger event; select at least one item for evaluation; for each selected item: hash the item; select a first array structure; allocate the hash value into an array index; and determine a bit value at a position of the array index in the first array structure; and report results of determining the bit value using a blockchain ledger. An item may be a message, file, or hardware technology configuration.

Some methods for ensuring trustworthy configuration, implemented on at least one processor, may comprise: at each of a plurality of endpoint nodes, receiving array structure data; detecting a trigger event at an endpoint node in the plurality of endpoint nodes; selecting at least one item, at the endpoint node for evaluation; at the endpoint node, for each selected item: hashing the item; selecting a first array structure; allocating the hash value into an array index; and determining a bit value at a position of the array index in the first array structure; and reporting results of determining the bit value using a blockchain ledger.

One or more exemplary computer storage devices having a first computer-executable instructions stored thereon for ensuring trustworthy configuration, which, on execution by a computer, cause the computer to perform operations which may comprise: at each of a plurality of endpoint nodes, receiving array structure data; detecting a trigger event at an endpoint node in the plurality of endpoint nodes; selecting at least one item at the endpoint node for evaluation; at the endpoint node, for each selected item: hashing the item; selecting a first array structure; allocating the hash value into an array index; and determining a bit value at a position of the array index in the first array structure; and reporting results of determining the bit value using a blockchain ledger.

Alternatively, or in addition to the other examples described herein, examples include any combination of the following: the first array structure is a multi-dimensional array; the first array structure corresponds to a known good, allowable, or known vulnerable configuration; the instructions are further operative to: select a second array structure and determine a bit value at a position of the array index in the second array structure, and wherein reporting results comprises reporting results corresponding to both the first array structure and the second array structure; the second array structure corresponds to a different one of known good, allowable, and known vulnerable configurations than the first array structure; reporting results comprises reporting results using peer-to-peer communication; and the instructions are further operative to: identify a configuration to be indicated in an array structure, and distribute array structure data including the identified configuration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary environment for using an array structure for ensuring trustworthy configuration.

FIG. 2 illustrates an exemplary array structure.

FIG. 3 is a diagram of an exemplary process flow for some embodiments.

FIG. 4 is an exemplary flow chart illustrating a process that may be used in some embodiments to ensure trustworthy configuration.

FIG. 5 is an exemplary block diagram illustrating an operating environment for a computing device that may for use an array structure for ensuring trustworthy configuration.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . .” For brevity and clarity of presentation, this implied leading clause is not repeated ad nauseum.

Referring to the figures, examples of the disclosure permit nodes of a federated system to quickly and efficiently evaluate themselves for compliance or non-compliance with a set of requirements and detection of vulnerabilities. Both hardware and software configurations may be rapidly evaluated in real-time, using a multi-dimensional bit array, by hashing a configuration and using the value as a look-up index in a peer-to-peer distributed ledger. Speed is provided by the distributed process in which the nodes evaluate themselves, and scalability is achieved because the look-up speed is largely independent of increases in size and complexity. Blockchain technology ensures trustworthy data and stores allowable configurations according to hash values, and secure validated means of communication are leveraged to share results and updates.

Many private networks require a way to determine, track and validate technology configurations. Unfortunately, determining allowable configurations of technology among semi-autonomous information technology systems and applications may be time consuming and prone to error with centralized evaluation when there are complexities involved, such as required dependencies.

Aspects of the disclosure use hashing, to determine a look-up index in a multidimensional bit array, with distributed evaluation in a federated system having secure communication among nodes, enabling both real-time compliance evaluation and scaling with increases in increases in size and complexity. Each node evaluates itself, for compliance or non-compliance, against potentially three types of criteria:
1. Known good configurations;
2. Allowable configurations; and
3. Known vulnerabilities.

The known good configuration evaluation answers the question: “Is a particular configuration, that has previously been determined to be good, present within the node?” This enables ascertaining whether there has been configuration drift away from a known baseline or has instead remained consistent. Effectively, the known good configuration evaluation is a form of an integrity verification for the tested aspects of a particular node. The allowable configuration evaluation answers the question: “Is a detected configuration allowable?” This enables ascertaining whether any configurations that have been identified as present on a node require further investigation. For example, a positive result for this evaluation may mean that no further investigation is required, whereas a negative result can be used to flag potentially unknown configurations that may require further investigation. The known vulnerabilities evaluation answers a couple of questions. One is: “Is a particular configuration, that is known to be vulnerable, present within the node?” Another is: “Has a particular technology, that is slated for elimination (even if no actual vulnerability has been identified), present within the node?” These questions enable ascertaining whether any problematic (or potentially problematic) configurations require remediation. For example, some technologies that are no longer supported with updates, or perhaps incompatible with newer defenses, may be slated for elimination, even if no currently-documented vulnerabilities exist.

Evaluations may be binary—either a hash is found within the array (a positive result) or is not found (a negative result). Each node may run its own evaluation process on itself in real-time, being triggered by any item changes (new items added, items removed, and items altered), on a schedule, upon an update, or at any time upon demand. An item may be a message, file, or hardware technology configuration.

A master node or process may push out updates to the known good, allowable, or known vulnerabilities arrays, based upon recommendations from a security team that may be monitoring developments such as external sources identifying new vulnerability discoveries. For example, if the security team identifies that a particular configuration, which had previously been identified as a known good, is (credibly) reported to be vulnerable, then the security team may remove the corresponding hash from the known good configurations array and/or the allowable configurations array and also set the hash in the known vulnerabilities array. All of the updated arrays will then be pushed out to the nodes, possibly with a trigger for a new evaluation to begin. Each node, using the newly updated arrays, may then report on whether it has the problematic configuration.

As can be easily appreciated, for large-scale networks, this process may be considerably faster than a central master node attempting to evaluate each of the distant nodes by itself. Issues and problems may be identified nearly instantly, rather than waiting until a central evaluation process has reached a particular node with problems. An additional benefit is that upon any further trigger on any node, such as by an item being changed, that node automatically evaluates itself for reemergence of the newly-identified vulnerability. The evaluations may be for software, hardware, or a combination. Hardware configurations may be described in a defined-format file or bitstream that identifies the hardware with some degree of specificity and can be hashed. The software may be any type of file, including data and executable instructions.

The hashes may be selected from common algorithms, such as the SHA family of hashes; the particular hash used may be selected based upon the speed desired, and the possibility of collision. Typically, hashes that are more resistant to collision may be slower. For example, the SHA-1 is often faster than the SHA-256 in many implementations but is more prone to collision and may be more prone to preimage attacks. The hash values may be locally scanned against the peer-to-peer shared ledger. A blockchain is leveraged for a peer-based recording mechanism.

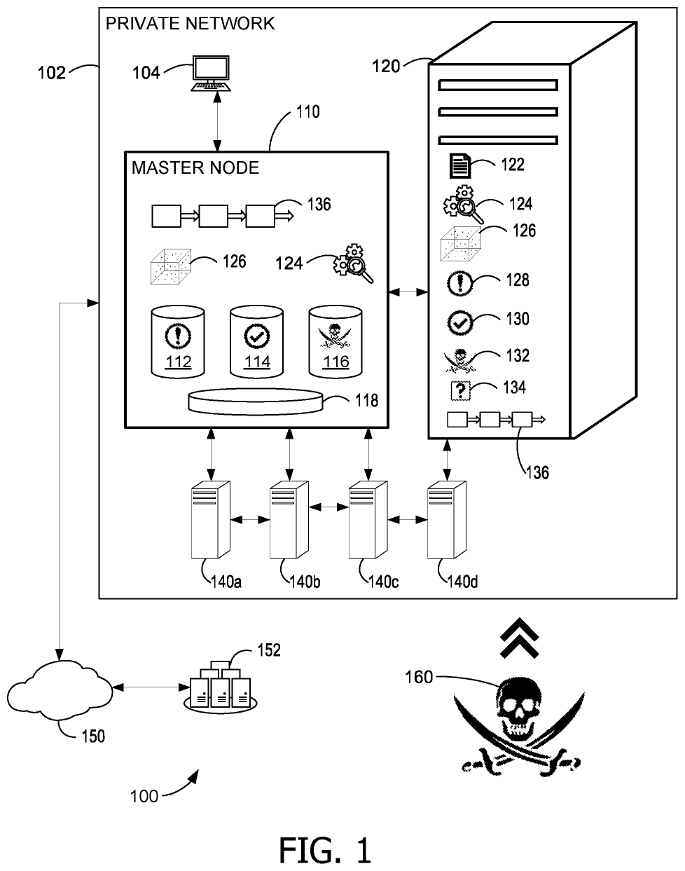

FIG. 1 illustrates an exemplary environment for using an array structure for ensuring trustworthy configuration. A private network 102 has a requirement for ensuring trusted operation and may advantageously use an array structure for ensuring trustworthy configuration. Network 102 has a user interface 104 and a master node 110. User interface 104 may be software running on master node 110 or may have its own hardware. Although only a single one of each user interface 104 and master node 110 are illustrated, it should be understood that some embodiments may have more than one user interface 104 and/or master node 110. A plurality of endpoint nodes are illustrated, such as an endpoint node 120, and additional endpoint nodes 140a-140d. The nodes 110, 120, and 140a-140d are illustrated as interconnected. It should be understood that an embodiment may include any number of nodes and any operable interconnection structure.

Network 102 communicates across another network 150, which may be a public network such as the internet, to one or more data sources 152 that may contain information related to vulnerabilities or the trustworthiness of a particular configuration. In operation, a security team member may employ user interface 104 to access data sources 152 in order to research vulnerabilities. Also, as illustrated, a threat 160 may attempt to enter network 102. Threat 160 represents both proactive attacks by hackers that seek to insert malware for exploitation, as well as latent vulnerabilities that may be inadvertently imported into network 102 through software and hardware installations.

Endpoint node 120 is illustrated as having several components. A file 122 represents an item to be hashed, such as a hardware configuration description or any type of data file or software file, such as executable instructions. An item may be a message, file, or hardware technology configuration. Any change to file 122 will trigger node 120 to check its own configuration, either checking only file 122 or also checking other files resident on or accessible to node 120. In some embodiments, only a select set of files, including system files, will act as triggers for evaluation; the same set may also be included within the evaluation, although it is possible to trigger on one set of files and evaluate another (although likely overlapping) set of files. A hash check module 124 has functionality to perform a hash operation on file 122 and check the results within a multi-dimensional array 126. Array 126 may contain indications of known good configurations, allowable configurations, or known vulnerabilities. Having a local copy of array 126 can speed the evaluation operation at endpoint node 120. As indicated, prior evaluations on node 120 have identified other files as a known good configuration 128, an allowable configuration 130, and a known vulnerability 132. Presumably, remediation actions should be underway for known vulnerability 132. In some situations, known vulnerability 132 may be used to represent older technology that has been slated for elimination, even if no actual vulnerability has yet been identified.

Another file has been identified as an unknown 134, because it was a negative result in a prior evaluation. Presumably, in some situations, such as based upon the file type, identifying a file as unknown 134 may trigger an investigation. For example, if unknown 134 is an executable file, it may be a relatively high priority candidate for investigation by a security team. Results are distributed among the different nodes, including node 120 using a shared ledger and blockchain 136. In some embodiments, each of nodes 140a-140d will also have copies of hash check module 124, array 126, and blockchain 136.

Master node 110 also has copies of hash check module 124, array 126, and blockchain 136. Master node 110 monitors and maintains the status of the stored master copies of results and configuration data, such as a known good configuration data set 112, an allowable configuration data set 114, and a known vulnerability data set 116. Results data 118, collected from the self-evaluation operations of nodes 120 and 140a-140d (along with possibly master node 110 itself), may be used to produce desired reports for the security team and other data consumers. It should be understood, however that any of data sets 112-118 may be stored remotely from master node 110 (such as, for example, on node 140a) and be accessed remotely by master node 110. Master node 110 further communicates with user interface user interface 104 to receive instructions for report generation; provide reports; receive updates to known good configuration data set 112, allowable configuration data set 114, and known vulnerability data set 116; and permit users to inspect directly the contents of data stored on master node 110.

In an exemplary operation, a security team uses user interface 104 to investigate new vulnerabilities identified in data sources 152 (across network 150), and identifies that a particular configuration, which had been previously used in network 120, now has an identified vulnerability. Functionality in hash check module 124 may be used to generate the hash used for investigating whether the configuration is represented in any of known good configuration data set 112, allowable configuration data set 114, and known vulnerability data set 116. In this example, consider that the configuration is located in allowable configuration data set 114, indicating that it is allowable. The security team then uses user interface 104 to update both allowable configuration data set 114 and known vulnerability data set 116, by removing the configuration from allowable configuration data set 114 and inserting it into known vulnerability data set 116. Master node 110 then pushes out the updates to endpoint nodes 120 and 140a-140d as an update to the various versions of array 126. Upon receiving the updates, each of nodes 120 and 140a-140d performs an evaluation and reports back to master node 110 whether the configuration is present. The data is stored in results data 118. The security team then uses user interface 104 to poll results data 118 and generate a report, and then can schedule remediation action.

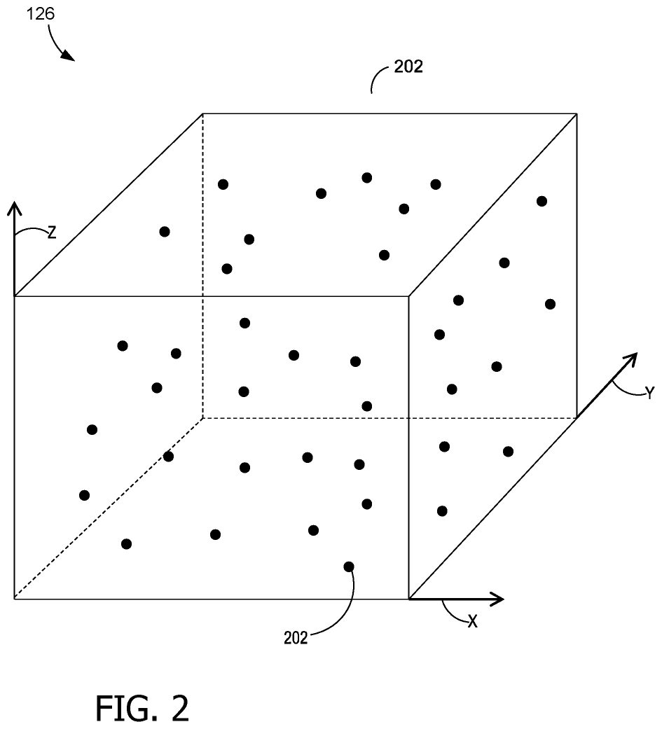

FIG. 2 illustrates an exemplary N-dimensional bit array structure 126. As indicated, array 126 may represent any of multiple different arrays, including known good configurations, allowable configurations, and known vulnerabilities (or configurations otherwise intended for elimination). That is, there may be multiple versions of a known vulnerability array, differentiated by severity of consequences and thus remediation priority. Although array 126 is illustrated as a three-dimensional (3D) array, it should be understood that any dimension may be used for an array or vector, in differing embodiments.

Accessing the array involves separating portions of a calculated hash value into array indices. For example, a hash value 123456789 may be separated into three components: x=123, y-456, and z=789. These values are used to check whether the bit at the corresponding (x,y,z) location is set to 1. If so, then the configuration is found in the array, and the result is returned as a positive. If the bit is set to 0, then the configuration is not found in the array, and the result is returned as negative. One feature of this arrangement is that, as the list of entries (whether known good, acceptable, or vulnerable) grows, the array remains the same size. Only the bit values change. Thus, the search time remains consistent with changes in the number of identified configurations (which is desirable for scalability). And because the hash is converted into an index, the bit containing the information may be located immediately, without the delay of searching through a list and checking each item until the proper one is located. The primary computation time is therefore the hash computation.

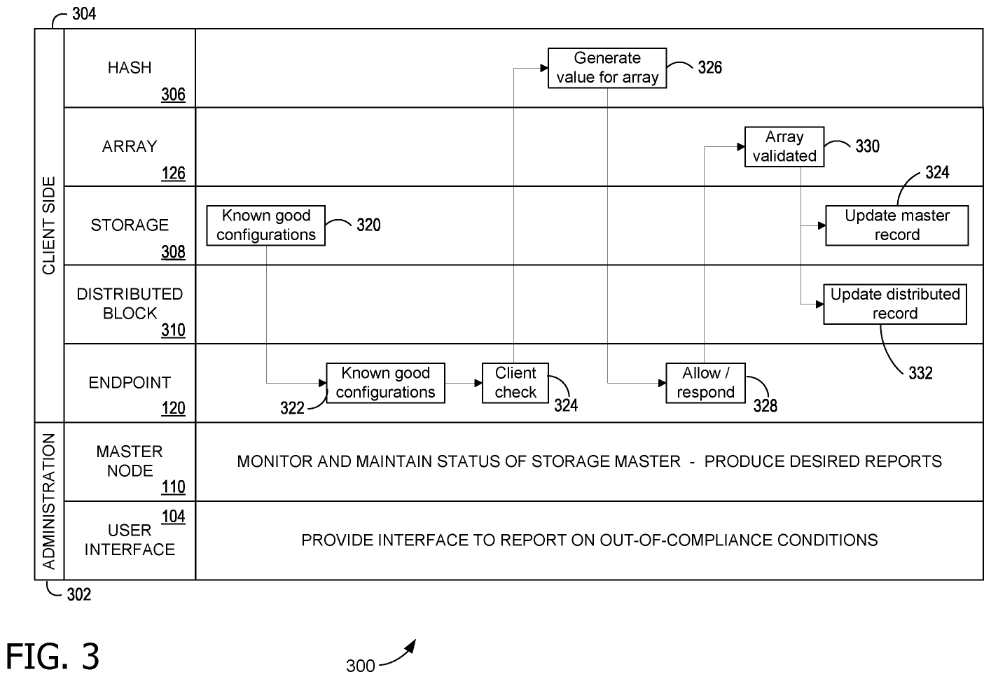

FIG. 3 is a diagram of an exemplary process flow 300 for some embodiments. Some embodiments have an administration component 302 with corresponding operations, and a client-side (endpoint node side) component 304 with corresponding operations. User interface 104 and master node 110 are illustrated at being within administration component 302. Endpoint node 120, a hash operation 306 (possibly performed by hash check module 124 (see FIG. 1) are illustrated at being within client-side component 304. Array 126 and distributed block 310 are shown within client-side component 304, although there may be copies of data residing on master node 110. Also, as illustrated, a storage function 308 is located within client-side component 304, although storage function 308 could either be located entirely or partially within administration component 302 for some embodiments.

As described previously, master node 110 monitors and maintains status of master storage function 308 and produces desired reports on network configuration health. User interface 104 provides an interface for a security team to generate reports on out-of-compliance conditions that may be used as a basis for remedial action. Update activity in process flow 300 begins with the identification of known good configurations 320. This may be a result of a security team study, or some other effort or operation. The known good configurations 320 are pushed to endpoint node 120, so that endpoint node 120 has its own local copy of known good configurations 322.

Hash operation 306 generates a hash value for the array in operation 326, which is used to determine whether the newly received data can be validated. A failure would result in a rejection of the data, and a response to master node 110 indicating this case. Presuming, however, that a valid hash value is calculated, endpoint node 120 allows the data update and responds to master node 110 in operation 328. Array 126 is validated in operation 330, and the new array data is ready to use locally for evaluation operations. This information is pushed out in a distributed record in operation 332, as part of a block in the blockchain functionality. Also, the master record is updated in storage 308 in operation 324. In some embodiments, endpoint node 110 uses distributed block 310 for the update to storage 308.

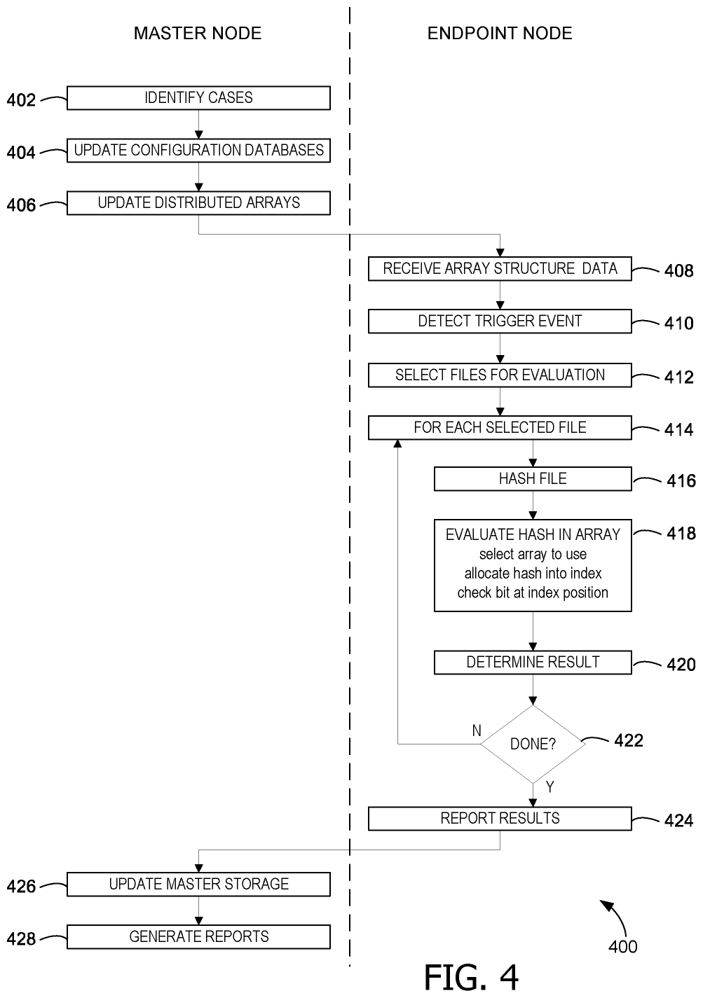

FIG. 4 is an exemplary flow chart illustrating a process 400 that may be used in some embodiments to ensure trustworthy configuration. As illustrated, there is a master node side and an endpoint node side (client side). The operations indicated on the endpoint node side may be performed at each of a plurality of endpoint nodes. In some examples, process 400 begins with identifying configuration cases at operation 402. This may include a security team searching for or otherwise identifying vulnerabilities, configurations to be discontinued, or other problem configurations. Alternatively, it could involve the security team validating a particular configuration and identifying it as an acceptable or desired configuration. Configuration databases are updated at operation 404, perhaps by storing them in databases (see data sets 112, 114, and 16 in FIG. 1) or by directly altering arrays (see FIG. 2). There is an update to distributed array structures at operation 406 that leverages secure peer-to-peer communication among the nodes. Together, operations 404 and 406 identify a configuration to be indicated in an array structure and distribute array structure data that includes the identified configuration. Updates may be distributed in a ledger, using blockchain functionality. In some embodiments, array structures may be distributed directly; in some embodiments information necessary for nodes to independently update or construct their own copies of the array structures is distributed.

At the endpoint node, the node receives array structure data at operation 408, and either replaces old array structures with a received version or a newly constructed version, or alternatively edits the current array structures. Whichever route taken, the endpoint node now has a local copy of the array structures that can be used for rapid evaluation. At some point, the endpoint node detects a trigger event at operation 410 to begin a check. This may be a result of receiving the update, a demand (for any reason) received from master node 110, a timer event, or a change in a monitored file, such as a hardware configuration definition, an executable software file, or a system file. The change may be an addition to a monitored directory folder, a deletion, or an alteration. The file or files at the endpoint node to be evaluated are selected at operation 412. This may be the new or changed file, or a larger set of files. An evaluation task is set up at operation 414 to individually hash each selected file at operation 416 and evaluate the hash in the array structure or array structures, at operation 418.

At operation 418, any of the different array cases described may be used alone or in combination with others. The process selects the particular array structure (or multiple array structures) to use, allocates the hash value into an array index, and checks the bit at the specified index position (see the description of FIG. 2). As described previously, the array structures may correspond to known good, allowable, or known vulnerable configurations. The bit value at the position indicated by the array index in the array structure, a positive or negative result, is determined at operation 420. The process at operation 422 determines whether additional files are to be checked, and results of determining the bit value are reported at operation 424. Results may be reported in a distributed block using blockchain functionality and will reach a master record storage location using the networks peer-to-peer communication, or some other communication route. If more than one array structure was used for evaluation, results are reporting corresponding to each of the first array structures used. At operation 426, the master node, or another node managing master record storage updates master storage at operation 426. Reports are generated at operation 428, such as reports on configuration health or the presence or absence of specific configurations. Reports may be triggered automatically, or on demand by a security team.

### Exemplary Operating Environment

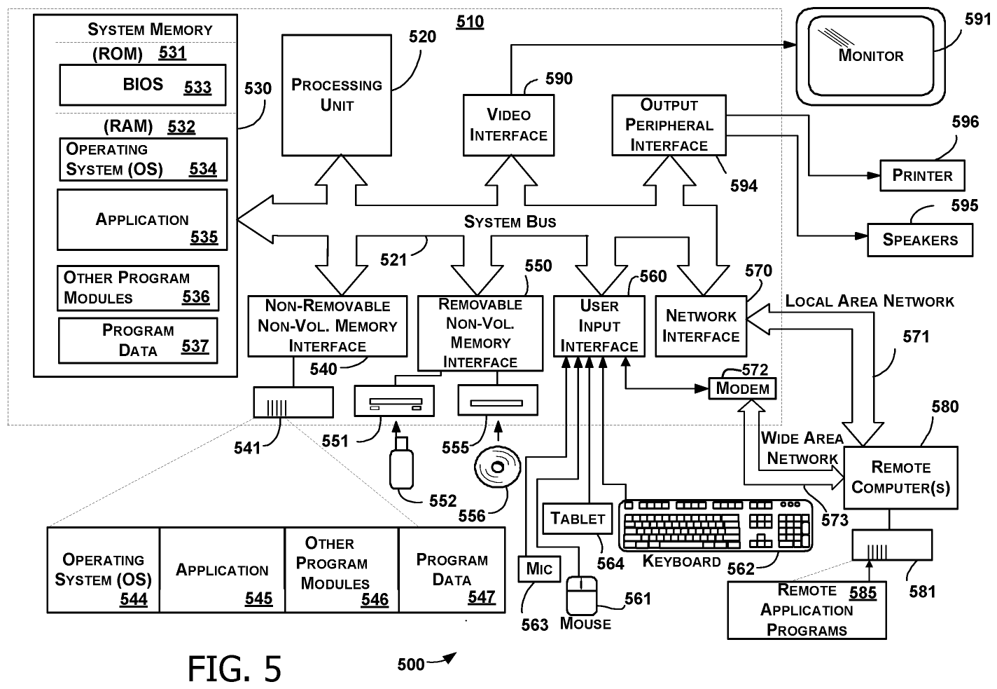

FIG. 5 is an exemplary block diagram illustrating an operating environment 500 for a computing device that may use an array structure for ensuring trustworthy configuration of the individual components of hardware and software (and their versions), combinations thereof and the environment as a whole. The computing system environment 500 is only one example of a suitable computing environment and is not intended to suggest any limitation as to the scope of use or functionality of the disclosure. Neither should the computing environment 500 be interpreted as having any dependency or requirement relating to any one or combination of components illustrated in the exemplary operating environment 500. The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 5, an exemplary system for implementing various aspects of the disclosure may include a general-purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media may be any available media that may be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 531 and 532 are examples of non-transitory computer-readable storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by the computer 510. Computer storage media does not, however, include propagated signals. Rather, computer storage media excludes propagated signals. Any such computer storage media may be part of computer 510.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 530 includes computer storage media in the form of volatile and/or nonvolatile memory such as read only memory (ROM) 531 and random-access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs, such as an application 535 that may perform operations described herein, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a universal serial bus (USB) port 551 that provides for reads from or writes to a removable, nonvolatile memory 552, and an optical disk drive 555 that reads from or writes to a removable, nonvolatile optical disk 556 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and USB port 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, an application 545 that may perform operations described herein, other program modules 546 and program data 547. Note that these components may either be the same as or different from operating system 534, optimization environment 535, other program modules 536, and program data 537. Operating system 544, optimization environment 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel may be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573 but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

### Exemplary Operating Methods and Systems

An exemplary system for ensuring trustworthy configuration, implemented on at least one processor, comprises: a plurality of endpoint nodes, each endpoint node comprising: a processor; and a non-transitory computer-readable medium storing instructions that are operative when executed by the processor to: receive array structure data; detect a trigger event; select at least one item for evaluation; for each selected item: hash the item; select a first array structure; allocate the hash value into an array index; and determine a bit value at a position of the array index in the first array structure; and report results of determining the bit value using a blockchain ledger.

An exemplary method for ensuring trustworthy configuration, implemented on at least one processor, comprises: at each of a plurality of endpoint nodes, receiving array structure data; detecting a trigger event at an endpoint node in the plurality of endpoint nodes; selecting at least one item at the endpoint node for evaluation; at the endpoint node, for each selected item: hashing the item; selecting a first array structure; allocating the hash value into an array index; and determining a bit value at a position of the array index in the first array structure; and reporting results of determining the bit value using a blockchain ledger.

One or more exemplary computer storage devices having a first computer-executable instructions stored thereon for ensuring trustworthy configuration, which, on execution by a computer, cause the computer to perform operations which may comprise: at each of a plurality of endpoint nodes, receiving array structure data; detecting a trigger event at an endpoint node in the plurality of endpoint nodes; selecting at least one item at the endpoint node for evaluation; at the endpoint node, for each selected item: hashing the item; selecting a first array structure; allocating the hash value into an array index; and determining a bit value at a position of the array index in the first array structure; and reporting results of determining the bit value using a blockchain ledger.

A system for ensuring trustworthy configuration implemented on at least one processor may comprise: a processor; and a non-transitory computer-readable medium storing instructions that are operative when executed by the processor, the instructions comprising logic for implementing any of the methods or processes disclosed herein.

Alternatively, or in addition to the other examples described herein, examples include any combination of the following:
the first array structure is a multi-dimensional array;
the first array structure corresponds to a known good, allowable, or known vulnerable configuration;
the instructions are further operative to: select a second array structure and determine a bit value at a position of the array index in the second array structure, and wherein reporting results comprises reporting results corresponding to both the first array structure and the second array structure;
the second array structure corresponds to a different one of known good, allowable, and known vulnerable configurations than the first array structure;
reporting results comprises reporting results using peer-to-peer communication; and
the instructions are further operative to: identify a configuration to be indicated in an array structure, and distribute array structure data including the identified configuration.

The examples illustrated and described herein as well as examples not specifically described herein but within the scope of aspects of the disclosure constitute an exemplary entity-specific value optimization environment. The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for ensuring trustworthy configuration, implemented on at least one processor, the system comprising:
a plurality of endpoint nodes, each endpoint node comprising:
a processor; and
a non-transitory computer-readable medium storing instructions that are operative when executed by the processor to:
receive array structure data;
detect a trigger event;
select at least one item for evaluation;
for each selected item:
hash the item;
select a first array structure;
allocate the hash value into an array index; and
determine a bit value at a position of the array index in the first array structure; and
report results of determining the bit value using a blockchain ledger.

2. The system of claim 1 wherein the first array structure is a multi-dimensional array.

3. The system of claim 1 wherein the first array structure corresponds to a known good, allowable, or known vulnerable configuration.

4. The system of claim 1 wherein the instructions are further operative to:
select a second array structure; and
determine a bit value at a position of the array index in the second array structure; and
wherein reporting results comprises reporting results corresponding to both the first array structure and the second array structure.

5. The system of claim 4 wherein the second array structure corresponds to a different one of known good, allowable, and known vulnerable configurations than the first array structure.

6. The system of claim 1 wherein reporting results comprises reporting results using peer-to-peer communication.

7. The system of claim 1 wherein the instructions are further operative to:
identify a configuration to be indicated in an array structure; and
distribute array structure data including the identified configuration.

8. A method for ensuring trustworthy configuration, implemented on at least one processor, the method comprising:
at each of a plurality of endpoint nodes, receiving array structure data;
detecting a trigger event at an endpoint node in the plurality of endpoint nodes;
selecting at least one item at the endpoint node for evaluation;
at the endpoint node, for each selected item:
hashing the item;
selecting a first array structure;
allocating the hash value into an array index; and
determining a bit value at a position of the array index in the first array structure; and
reporting results of determining the bit value using a blockchain ledger.

9. The method of claim 8 wherein the first array structure is a multi-dimensional array.

10. The method of claim 8 wherein the first array structure corresponds to a known good, allowable, or known vulnerable configuration.

11. The method of claim 8 further comprising:
selecting a second array structure; and
determining a bit value at a position of the array index in the second array structure; and
wherein reporting results comprises reporting results corresponding to both the first array structure and the second array structure.

12. The method of claim 8 wherein the second array structure corresponds to a different one of known good, allowable, and known vulnerable configurations than the first array structure.

13. The method of claim 8 wherein reporting results comprises reporting results using peer-to-peer communication.

14. The method of claim 8 further comprising:
identifying a configuration to be indicated in an array structure; and
distributing array structure data including the identified configuration.

15. One or more computer storage devices having a first computer-executable instructions stored thereon for ensuring trustworthy configuration, which, on execution by a computer, cause the computer to perform operations comprising:
at each of a plurality of endpoint nodes, receiving array structure data;
detecting a trigger event at an endpoint node in the plurality of endpoint nodes;
selecting at least one item at the endpoint node for evaluation;
at the endpoint node, for each selected item:
hashing the item;
selecting a first array structure;
allocating the hash value into an array index; and
determining a bit value at a position of the array index in the first array structure; and
reporting results of determining the bit value using a blockchain ledger.

16. The one or more computer storage devices of claim 15 wherein the first array structure is a multi-dimensional array.

17. The one or more computer storage devices of claim 15 wherein the first array structure corresponds to a known good, allowable, or known vulnerable configuration.

18. The one or more computer storage devices of claim 15 wherein the operations further comprise:
selecting a second array structure; and
determining a bit value at a position of the array index in the second array structure; and
wherein reporting results comprises reporting results corresponding to both the first array structure and the second array structure.

19. The one or more computer storage devices of claim 15 wherein the second array structure corresponds to a different one of known good, allowable, and known vulnerable configurations than the first array structure.

20. The one or more computer storage devices of claim 15 wherein reporting results comprises reporting results using peer-to-peer communication.
